(19) United States
(12) Patent Application Publication
(10) Pub. No.: US 2012/0031436 A1
(43) Pub. Date: Feb. 9, 2012

(54) CLEANING THE SHELL SIDE OF A HEAT EXCHANGER CORE

(75) Inventor: Michjael Watson, Essex (GB)

(73) Assignee: TUBE TECH INTERNATIONAL LTD, Rayleigh, Essex (GB)

(21) Appl. No.: 13/262,945

(22) PCT Filed: Mar. 30, 2010
(86) PCT No.: PCT/IB2010/051380

§ 371 Date: Oct. 5, 2011

(30) Foreign Application Priority Data
Apr. 20, 2009 (GB) 0906647.3

(51) Int. Cl. B08B 9/032

(52) U.S. Cl. 134/22.12

(57) ABSTRACT

A method is disclosed for cleaning the shell side of the core of a heat exchanger formed of a set of tubes passing through transverse plates which include two end plates and at least one baffle plate. A hole is first formed in an end plate in a region between core tubes. A lance is next inserted into through the hole and used to jet the section of the core between the end plate and the first baffle plate. A boring tool inserted through the hole in the end plate is then used to drill a hole in the baffle, allowing the cleaning process to be repeated for further sections of the core.

### FIELD OF THE INVENTION

The present invention relates to cleaning the shell side of a heat exchanger core.

### BACKGROUND OF THE INVENTION

FIGS. 1 to 3 of the accompanying drawings show the design of known heat exchangers. FIG. 1 is a vertical cross section through the heat exchanger while FIGS. 2 and 3 show alternative tube face cross sections taken in the plane II-II in FIG. 1. The heat exchanger comprises a shell 10 and a core 12. The core has two end plates 14, 16 which define headers 18, 20 at the top and the bottom of the shell 10. A set of tubes 22 is welded or expanded or both in holes in the two end plates 14, 16 to define fluid flow passages between the two headers and baffle plates 24, 26 support the tubes 22 along their length and maintain the spacing between them.

The tubes 22 can be arranged in a square pitch array, as shown in FIG. 2 with a typical spacing of 10 mm or less or in a triangular pitch array as shown in FIG. 3 with a typical spacing of 10 mm or less, the latter allowing a greater density of tubes.

In use, a first fluid is pumped via inlets and outlets 28 and 30 to flow through the tubes 22 and a second fluid is pumped via connectors 32 and 34 to flow through the shell 10. The tubes are made of a good thermal conductor, so that a transfer of heat takes place between the two fluids during their passage through the heat exchanger.

Prolonged flow of fluids through the shell and the tubes can result in the formation of deposits and a reduction in the efficiency of the heat exchanger. It is therefore essential at intervals to clean the heat exchangers to remove such deposits.

The conventional way of cleaning the shell side of the core is first to remove the entire core from the shell and them to use high pressure water jetting. Narrow jets of water at typically between 1000 psi and 40,000 psi emitted from the front end of a lance are aimed at the outermost surfaces of the tube nest to be cleaned which are sufficient to dislodge deposits adhering to the outer surfaces of the tubes.

Conventional lances consist of a tube about 10 mm in outer diameter with a jet nozzle at its tip. Because of its large outer diameter, when cleaning a core of the type shown in FIG. 3, a conventional lance cannot be inserted between the tubes of the core and the high pressure jetting is carried out with the nozzle outside the core in the hope that the water will penetrate between the tubes and remove the deposit form scaled tubes. In the case of the core of FIG. 2, a lance can be inserted into the two wider slots provided for this purpose and the lance may be provided with lateral nozzles but the lance cannot be inserted between all the tubes of the heat exchanger.

The effectiveness of a high pressure jet decreases as the distance from the nozzle to the surface being cleaning increases. For this reason, when using a large diameter lance, only the visibly accessible outer tubes near to the outside of the core can be cleaned efficiently.

It has been proposed in JP-5616899 to remove the header and to insert a lance into the core and advance it parallel to the core tubes. The lance is introduced through a hole that is pre-drilled in the end plate and that is accessed by removal of a blanking plug. Further pre-drilled holes are formed in baffles plates so that a lance can be advanced over the full length of the core. The holes in the baffle plates do not need blanking plugs as the baffle plates are only used for support, not to separate chambers containing different fluids.

The problem with this proposal is that it can only be used to simplify the cleaning of heat exchangers that have been modified during their manufacture and it cannot be used to clean the vast majority of heat exchanger that are already in use and that do not permit a lance to be introduced into the heat exchanger core and advanced in this manner.

### OBJECT OF THE INVENTION

The present invention seeks therefore to provide a method of cleaning the shell side of the core of a heat exchanger that allows the entire core to be cleaned.

### SUMMARY TO THE INVENTION

According to the present invention, there is provided A method of cleaning the shell side of the core of a heat exchanger formed of a set of tubes passing through transverse plates which include two end plates and at least one baffle plate, which method comprises the steps of :

a) providing a hole in an end plate of the core in a region between core tubes,

b) inserting a lance into the core through the hole,

c) emitting a water jet from the lance to dislodge any deposits ahead of the tip of the lance and deposits adhering to the shell side surfaces of the adjacent core tubes, and

d) advancing the lance in a direction parallel to the core tubes until a baffle plate is reached,

characterised by the steps of

e) inserting a boring tool through the hole, and

f) piercing a hole in the baffle so as to enable steps b) to e) to be repeated.

As conventional core do not have pre-drilled holes in their end plates, step a) usually involves removing a header of the heat exchanger to gain access to the end plate and subsequently piercing the hole in the end plate.

Preferably, step e) comprises inserting through the previously bored hole(s) a radially expandable guide to contact the cleaned shell side surfaces of adjacent core tubes, the guide serving to align a boring tool inserted through the previously bored hole(s) with a point on the next transverse plate equidistant from the adjacent core tubes.

Each pierced hole will serve to clean the shell side of several adjacent core tubes but a single such hole would not suffice to clean out the entire core. However, the process can be repeated across the section of the heat exchanger until all the core has been cleaned.

The cleaning process can be carried from only one end or from both ends. Working from both ends can reduce the time taken to clean the whole core and also reduced the length of the boring tools that are needed.

After completion of cleaning, it would suffice to plug the holes bored in the end plates only. However, if desired, the holes in intermediate baffle plates may also be blocked off my inserting a tube or rod into the axially aligned holes bored in the plates and sealing the ends of each tube or rod relative to the two end plates of the core.

### BRIEF DESCRIPTION OF THE DRAWINGS

The invention will now be described further, by way of example, with reference to the accompanying drawings, in which:

FIG. 1 is, as earlier described, a vertical section through a conventional heat exchanger,

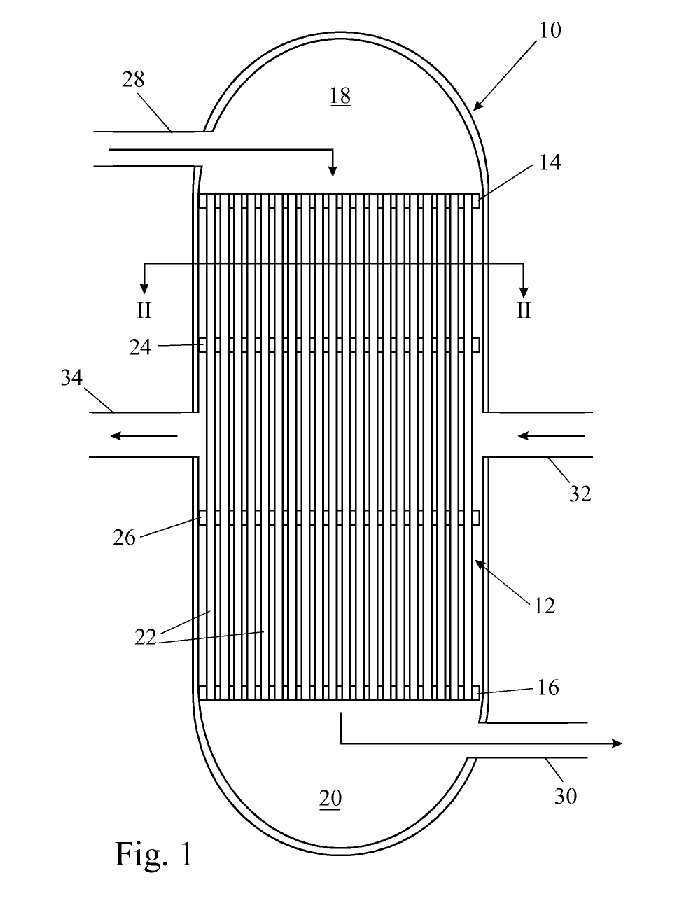

FIGS. 2 and 3, also as earlier described, show sections taken through the line II-II in FIG. 1 of two heat exchangers having different tube configurations, and

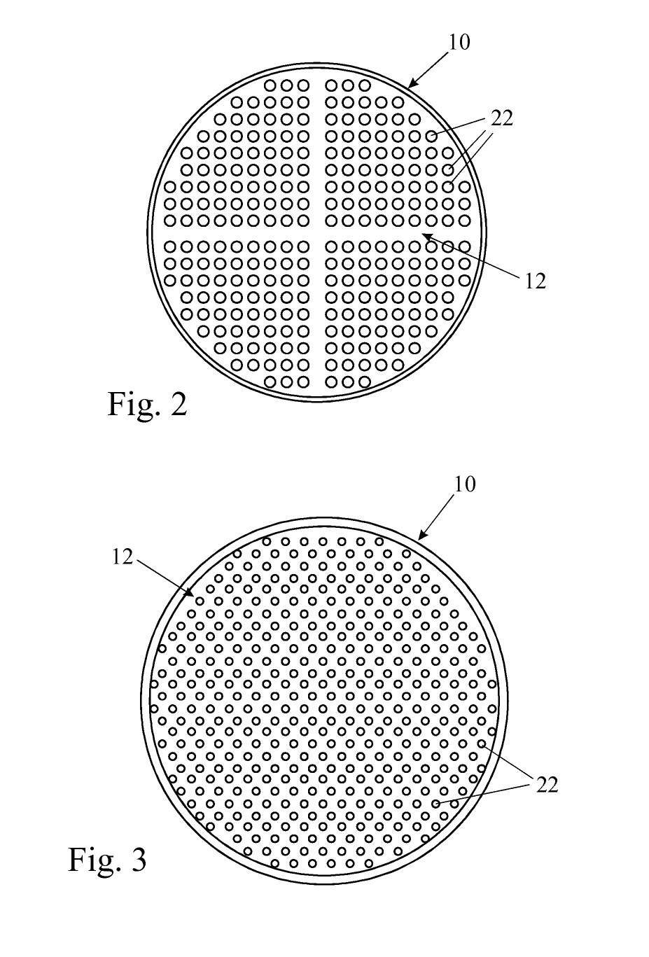

FIG. 4 shows the cleaning of five different locations in a heat exchanger core, each location being at a different stage of being cleaned using the method of the present invention.

### DETAILED DESCRIPTION OF THE PREFERRED EMBODIMENT

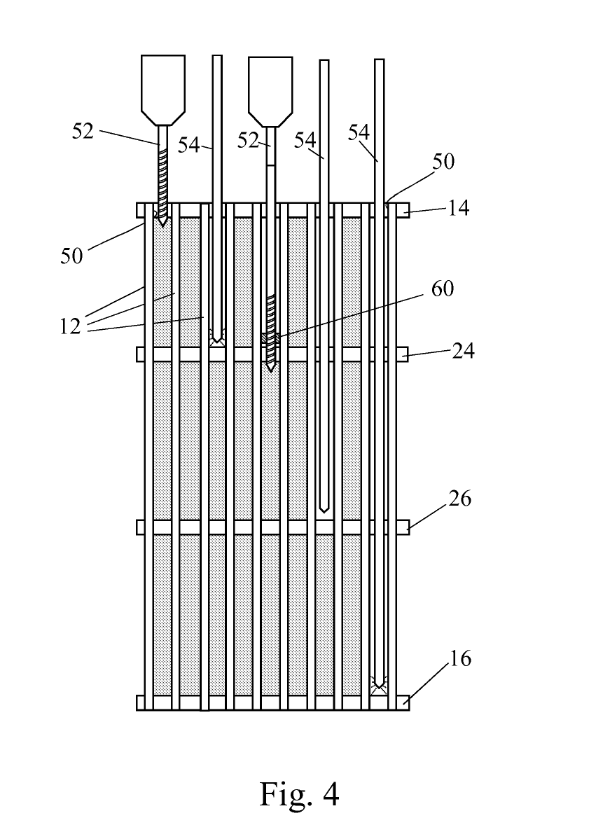

In FIG. 4, the shell side of a heat exchanger core 12 is shown being cleaned after removal of the core 12 from the shell 10. it should be mentioned, however, that the method of the invention can be implemented without extracting the core from the shell 10. It would suffice to remove a head of the exchanger and to expose only the top plate 14.

In FIG. 4, the shaded areas represent the deposit that forms on the outer surfaces, i.e. the shell side surfaces, of the tubes 12 and prevents fluid from flowing across the tubes. To remove this deposit, a hole 50 is pierced in the top plate 14 using a drill 52 as shown on the left of the drawing.

The next stage involves inserting a high pressure lance 54 through the hole 50 and jetting the shell side surfaces of the core tubes 12. The same or different lances 54 can have forward, sideways and rearward facing jets. The forward facing jets clear the deposit ahead of the lance and create a path for the lance. The lateral jets clean the outer surfaces of tubes 12 and rearward facing jets assist in ejecting the debris created by the jetting.

The high pressure fluid jetting continues until the lance reaches the baffle plate 24 as shown for the second hole from the left in FIG. 4. At this point, the lance cannot penetrate any further into the core and is withdrawn.

To enable the cleaning to be continued, it is necessary to pierce through the baffle plate 24 in the same manner as a hole was drilled in the end plate 14. However, whereas the drill 52 could be centred visually between the tubes 12 when drilling into the end plate 14, special steps have to taken to centre the boring tool relative to the adjacent tubes 12 when making a hole in the baffle plate 24 because drilling indiscriminately could result in one or more of the tubes 12 being punctured.

The centring of the boring tool 52 while piercing the baffle plate is carried out using a radially expandable guide 60 that is inserted through the predrilled hole 50. The radially expandable guide, which can take on many forms, is designed to contact outer surfaces of the tubes 12 that have already been cleaned and to provide a bore for guiding the drill bit. The guide may for example comprise a mechanism operating on the same principle as an iris shutter, or it may comprise a bladder that is inflatable by hydraulic or pneumatic pressure. A further possible construction comprises two rings connected to opposite ends of a slotted tube or bellows which expands radially when its ends are axially pushed towards one another.

The choice of guide is not fundamental to the present invention so long as it enables a hole to be drilled into the baffle plate 24 which is substantially equidistant from the adjacent tubes 12. The hole formed while the boring tool is guided need not be large enough to accept a lance and it need only be a pilot hole. As such, the hole can be formed using a laser cutter or a high pressure water jet containing particles of an abrasive such as garnet. Once a pilot hole has been formed, it can be enlarged by the use a conventional boring tool, such as a drill, so that it may accept a lance.

Both the lance 54 and the boring tool 52 can be formed in sections that can be assembled to extend them to the length that is needed. It is thus possible to remove the deposit from the outer surfaces of the tubes 12 in the section lying between the two baffle plates 24 and 26. This is represented by the second hole from the right in the drawing.

The drilling of holes in transverse plates is continued until eventually the opposite end plate 16 is reached. It is not necessary to drill through the end plate 16 and therefore the last hole on the right shows the position of the lance upon completion of the cleaning process. If the cleaning is commenced from both ends, then it is would be the baffle at which the holes commenced from the opposite ends meet that would not need to be pierced.

Each hole will only clean the tubes in the vicinity of the hole and the process therefore needs to be repeated several times over the cross section of the core.

After completion of the shell side cleaning, there will be holes left in the end plate 14 as well as the baffle plates 24 and 26. So long as the baffle plates 24 and 26 are not weakened by the holes, there is no reason for them not to be allowed to remain. The holes in the end plate 14 must however be plugged to prevent the fluid on the shell side of the core from mixing with the fluid flowing through the tubes 12. If it is desired to plug the holes in the baffle plates 24 and 26 as well as the holes in the end plate 14, this can be achieved by inserting tubes down the length of the core and sealing between the ends of the tubes and the end plates.

1. A method of cleaning the shell side of the core of a heat exchanger formed of a set of tubes passing through transverse plates which include two end plates and at least one baffle plate, which method comprises the steps of:
a) providing a hole in an end plate of the core in a region between core tubes,
b) inserting a lance into the core through the hole,
c) emitting a water jet from the lance to dislodge any deposits ahead of the tip of the lance and deposits adhering to the shell side surfaces of the adjacent core tubes, and
d) advancing the lance in a direction parallel to the core tubes until a baffle plate is reached,
characterised by the steps of
e) inserting a boring tool through the hole, and drilling a hole in the baffle so as to enable steps b) to e) to be repeated.

2. A method as claimed in claim 1, wherein step a) comprises removing a header of the heat exchanger to gain access to the end plate and subsequently drilling the hole in the end plate.

3. A method as claimed in claim 1, wherein step e) comprises inserting through the previously bored hole(s) a radially expandable guide to contact the cleaned shell side surfaces of adjacent core tubes, the guide serving to align the boring tool inserted through the previously bored hole(s) with a point on the next transverse plate equidistant from the adjacent core tubes.

4. A method as claimed in claim 3, wherein all the steps are repeated across the cross section of the heat exchanger, commencing from one or both end plates, until all the core has been cleaned.

5. A method as claimed in claim 1, wherein, after completion of cleaning, the holes bored in the end plates are plugged.

6. A method as claimed in claim 5, wherein the holes in intermediate plates are also blocked off my inserting a tube or rod into the axially aligned holes bored in the plates and sealing the ends of each tube or rod relative to the end plates of the core.
